(19) United States
(12) Patent Application Publication
(10) Pub. No.: US 2020/0298984 A1
(43) Pub. Date: Sep. 24, 2020

(54) AIRBAG SYSTEMS FOR USE ON AIRCRAFT

(71) Applicant: AmSafe, Inc., Phoenix, AZ (US)

(72) Inventor: Bradley Scott Walker, Gilbert, AZ (US)

(21) Appl. No.: 16/358,354

(22) Filed: Mar. 19, 2019

(51) Int. Cl. B64D 25/04; B64D 25/06; B64D 11/06

(52) U.S. Cl. CPC B64D 25/04; B64D 2201/00; B64D 11/06205; B64D 25/06

(57) ABSTRACT

Airbag systems for use in aircraft are described herein. In some embodiments, an occupant restraint system for use with a passenger seat on an aircraft includes an under-seat airbag having a leg restraint portion. The under-seat airbag can be stowed approximate to a seat pan prior to use. In operation, the under-seat airbag can inflate to reduce occupant forward head path excursion and/or forward extension of the occupant's legs during a crash or other rapid deceleration event.

### TECHNICAL FIELD

The present disclosure is generally related to airbags and associated systems and methods for use in aircraft and other vehicles.

### BACKGROUND

Airbags can protect occupants from strike hazards in automobiles, aircraft, and other vehicles. In conventional airbag systems, a sensor detects a collision or other dynamic event of sufficient magnitude and transmits a corresponding signal to an initiation device on an inflator. The signal causes the inflator to immediately release compressed gas into the airbag, rapidly inflating the airbag in front of the occupant to cushion the impact with forward objects.

Some aircraft include airbags on seat belts that are secured around the occupant's waist in a conventional manner. The airbag is typically stowed on the seat belt under a flexible cover. In the event the aircraft experiences a forward impact or other significant dynamic event, the airbag rapidly inflates, displacing the cover and deploying upwardly in front of the occupant to create a cushioning barrier between the occupant and the seat back, partition, monument, or other potential strike hazard in front of the occupant.

Forward head excursion during a crash event can limit how close rows of passenger seats can be placed behind each other, and how close seats can be positioned relative to a partition wall or other forward strike hazard. Accordingly, it is generally desirable to reduce forward head excursion so that passenger seats can be placed closer to potential strike hazards, while still maintaining enough distance to ensure that occupants do not contact the strike hazards during a crash event. Additionally, it can also be desirable to reduce forward leg extension or flail in response to a crash event to further reduce the potential for occupant injury.

### BRIEF DESCRIPTION OF THE DRAWINGS

FIG. 1 is a front isometric view of an occupant secured in an aircraft seat having an under-seat airbag with a leg restraint portion configured in accordance with embodiments of the present technology.

FIG. 2 is a partially schematic isometric view of an aircraft airbag system configured in accordance with embodiments of the present technology.

FIGS. 3A-3C are a top isometric, side, and top view, respectively, of an under-seat airbag having a leg restraint portion configured in accordance with embodiments of the present technology.

FIGS. 4A-4C are a series of side isometric views illustrating various stages of operation of an under-seat airbag having a leg restraint portion configured in accordance with embodiments with the present technology.

FIG. 5 is a front isometric view of an occupant secured in aircraft seat having an under-seat airbag with a leg restraint portion and a lap belt airbag configured in accordance with embodiments of the present technology.

FIG. 6 is a partially schematic isometric view of an aircraft airbag system configured in accordance with another embodiment of the present technology.

FIGS. 7A-7C are a rear, front, and side view, respectively, of a lap belt airbag configured in accordance with embodiments of the present technology.

FIGS. 8A-8C are a series of side views illustrating various stages of operation of an occupant restraint system having an under-seat airbag and a lap belt airbag configured in accordance with embodiments of the present technology.

### DETAILED DESCRIPTION

The following disclosure describes various embodiments of airbags and associated systems and methods for use with seats in aircraft. As described in greater detail below, and some embodiments the airbag systems can include an under-seat airbag having a first portion configured to inflate beneath the occupant's thighs and a second airbag portion configured to inflate in front of the occupant's lower legs. If the aircraft experiences a significant dynamic event (e.g., a crash event or other rapid deceleration) in which the occupant could be thrown forward against a seatback or other potential strike hazard, an electronic sensing system automatically activates an inflator to immediately release compressed gas into the under-seat airbag, causing the airbag rapidly to inflate. As the first portion of the under-seat airbag inflates, it presses upwardly on the occupant's thighs just behind the knees, driving the occupant's legs upwardly toward the occupant's torso. The upward momentum of the occupant's legs reduces the forward rotation of the occupant's torso about the lap belt, thereby reducing forward head excursion and potential injuries to the occupant. At the same time, the second airbag portion deploys outwardly between the occupant's legs and inflates laterally in front of the occupant's shins, thereby restraining forward motion and extension of the legs in response to the dynamic event. In other embodiments, the under-seat airbag can be used in combination with a lap belt airbag that inflates between the occupant's torso and thighs. In these embodiments, the upward momentum of the occupant's legs is reacted by the occupant's torso through the lap belt airbag. As a result, in some embodiments using the lap belt airbag with the under-seat airbag may reduce forward head excursion more than if the under-seat airbag was used alone.

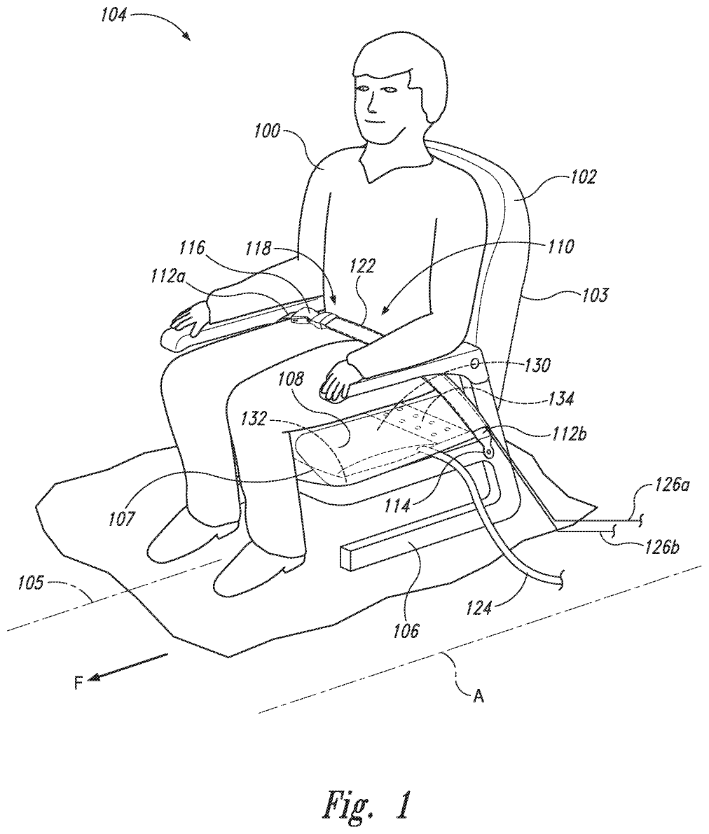

Certain details are set forth in the following description and in FIGS. 1-8C to provide a thorough understanding of various embodiments of the present technology. In other instances, other details describing well-known structures, materials, methods and/or systems often associated with airbags, airbag inflation systems and related circuitry, seat belts, seats, etc. in aircraft and other vehicles are not shown or described in detail in the following disclosure to avoid unnecessarily obscuring the description of the various embodiments of the technology. Those of ordinary skill in the art will recognize, however, that the present technology can be practiced without one or more of the details set forth herein, or with other structures, methods, components, and so forth.

The terminology used below is to be interpreted in its broadest reasonable manner, even though it is being used in conjunction with a detailed description of certain examples of embodiments of the technology. Indeed, certain terms may even be emphasized below; however, any terminology intended to be interpreted in any restricted manner will be overtly and specifically defined as such in this Detailed Description section.

The accompanying Figures depict embodiments of the present technology and are not intended to be limiting of its scope. The sizes of various depicted elements are not necessarily drawn to scale, and these various elements may be arbitrarily enlarged to improve legibility. Component details may be abstracted in the Figures to exclude details such as position of components and certain precise connections between such components when such details are unnecessary for a complete understanding of how to make and use the invention.

Many of the details, dimensions, angles and other features shown in the Figures are merely illustrative of particular embodiments of the disclosure. Accordingly, other embodiments can have other details, dimensions, angles and features without departing from the spirit or scope of the present invention. In addition, those of ordinary skill in the art will appreciate that further embodiments of the invention can be practiced without several of the details described below.

In the Figures, identical reference numbers identify identical, or at least generally similar, elements. To facilitate the discussion of any particular element, the most significant digit or digits of any reference number refers to the Figure in which that element is first introduced. For example, element 110 is first introduced and discussed with reference to FIG. 1.

FIG. 1 is a front isometric view of a seat occupant 100 (e.g., a passenger) secured in a seat 102 by a restraint system 110 having a lap seatbelt 118 and an under-seat airbag 130 configured in accordance with embodiments with the present technology. In the illustrated embodiment, the seat 102 is positioned in an aircraft seating area 104, such as a passenger cabin of a commercial, private, or general aviation aircraft. For example, in some embodiments, the seat 102 can be at least generally similar in structure and function to a conventional seat in, for example, a first class or business class cabin of a commercial passenger aircraft. Accordingly, the seat 102 includes a back portion 103 extending upwardly from a base portion 107 in a conventional manner. The base portion 107 can include a seat pan 132 that supports a seat cushion 108 (e.g. a foam cushion) upon which the occupant 100 sits. Prior to installation on/in the seat 102, the under-seat airbag 130 is folded and stowed within a flexible protective cover 134. The covered under-seat airbag 130 is then installed on the seat pan 132 beneath the seat cushion 108, or beneath at least a portion of the seat cushion 108. In other embodiments, the under-seat airbag 130 can be integrated into the seat cushion 108 by, for example, positioning the under-seat airbag 130 in a cavity formed in the seat cushion. A gas conduit or hose 124 extends from the under-seat airbag 130 and is operably coupled in fluid communication to an airbag inflator (not shown in FIG. 1).

In the illustrated embodiment, the lap seatbelt 118 (which can also be referred to as “two-point” restraint) includes a first web portion 112a and a second web portion 112b. The web portions 112a, b can be at least generally similar in structure and function to conventional seatbelt webbing comprised of, for example, woven nylon, woven polyester, etc. A proximal end of the second web portion 112b is fixedly attached to a seat frame 106 on one side of the occupant 100 by an attachment fitting 114, and a proximal end of the first web portion 112a is similarly attached to the seat frame 106 on the opposite side of the occupant 100. A distal end of the first web portion 112a carries a buckle 116 that is configured to receive and releasably engage a corresponding web connector tongue (not shown in FIG. 1) attached to the distal end of the second web portion 112b. Additionally, in some embodiments a first electrical link, e.g., a first wire 126a, and a second wire 126b can be routed under a cover 122 on the second web portion 112b to a seatbelt switch (not shown) that completes a circuit or is otherwise operable to indicate when the connector tongue on the second web portion 112b is properly coupled to the buckle 116, which can be a precondition for deployment of the under-seat airbag 130. In operation, the occupant 100 secures the seatbelt 118 around his or her waist in a conventional manner. More specifically, after sitting in the seat 102, the occupant 100 can insert the connector tongue on the second web portion 112b into the buckle 116 and adjust the tension in the seatbelt 118 in a conventional manner. To release the seatbelt 118, the occupant 100 lifts a handle on the buckle 116 or otherwise releases the connector tongue from the buckle 116 in a conventional manner.

In the illustrated embodiment, the seat 102 faces forward, or at least generally forward, in direction F toward the front of the aircraft. Accordingly, in this embodiment, a centerline 105 of the seat 102 extends parallel to, or at least approximately parallel to, a longitudinal axis A of the aircraft (e.g., a longitudinal axis of the aircraft fuselage). In other embodiments, the seat 102 can be positioned so that the occupant 100 faces generally forward, but with seat centerline 105 orientated at an angle (e.g., an oblique angle) relative to the longitudinal axis A. For example, in such embodiments the seat centerline 105 can be positioned at angles from about 5 degrees to about 90 degrees, or from about 10 degrees to about 45 degrees, relative to the longitudinal axis A. In other embodiments, the seat can be positioned in other orientations and/or in other settings and arrangements. Additionally, as those of ordinary skill in the art will appreciate, although only one seat 102 is illustrated in FIG. 1, in some embodiments additional seats can be positioned to one or both sides of the seat 102 to create a row of seats, and/or in front of or behind the seat 102 in additional rows. In other embodiments, the seat 102 can be positioned behind a partition (e.g., a closet or galley wall), or other structure.

In some embodiments, the airbag and restraint systems described herein can be used to protect occupants in a wide variety of vehicles, including other types of aircraft (e.g., both fixed-and-rotary-wing aircraft), land vehicles (e.g., automobiles), watercraft, etc., and with a wide variety of seating arrangements and orientations, such as center aisle seats, outer aisle seats, seats positioned directly behind other seats, monuments, walls, partitions, consoles, closets, etc., “infinite setback seats” (seats that are not positioned behind other structures), and seats in other orientations relative to, for example, the forward end of the aircraft and/or the direction F of forward travel, such as side facing seats or seats orientated at other angles relative to the longitudinal axis A of the aircraft.

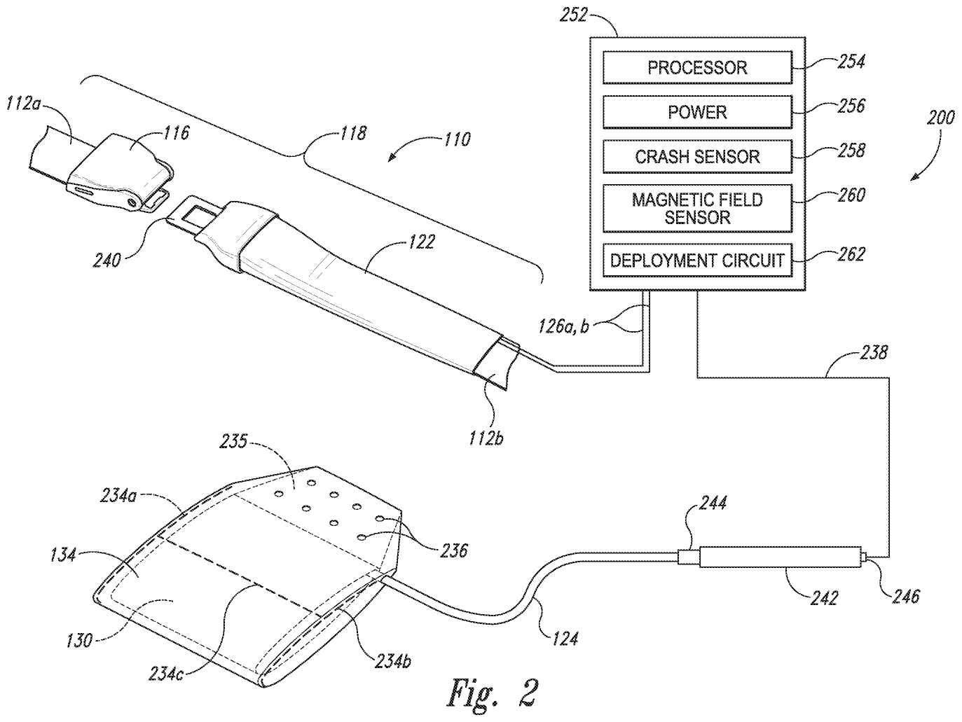

FIG. 2 is a partially schematic isometric view of the restraint system 110 and an associated airbag deployment system 200 configured in accordance with embodiments of the present technology. As noted above with reference to FIG. 1, the under-seat airbag 130 can be enclosed in a flexible and protective cover 134. The cover 134 can include can include one or more seams (e.g., tear seams) attached with stitching (e.g., “rip stitching”) that ruptures as the airbag 130 inflates so that the cover 134 does not restrain the under-seat airbag 130 as it rapidly expands. For example, the cover 134 can include a first side tear seam 234a and a second side tear seam 234b. Additionally, in some embodiments the cover can also include a lateral tear seam 234c extending between the two side tear seams 234a, b. The tear seams 234a-c can include stitching with suitable thread that is configured to break upon airbag inflation. In other embodiments, the tear seams 234a-c can employ adhesive or other means to hold the cover 134 together prior to inflation of the airbag 130. In addition to the tear seams 234a-c, the cover 134 can additionally include one or more holes 236 that extend through the cover 134 and an adjacent attachment panel 235 of the airbag 130. The holes 236 are configured to receive one or more fasteners (e.g., rivets, screws, adhesive, etc.; not shown in FIG. 2) that attach the airbag 130 and the cover 134 to the seat pan 132 (FIG. 1).

In some embodiments, the airbag deployment system 200 includes an electronic assembly 252 (e.g., an electronic module assembly (EMA); shown schematically) and an inflator 242. The electronic assembly 252 and/or the inflator 242 can be located, for example, under the seat 102 (FIG. 1), under an adjacent seat, or in other locations suitable for connectivity to the lap belt airbag 120 and the under-seat airbag 130. Various types of inflators known in the art can be used with the airbag systems described herein. In some embodiments, for example, the inflator 242 can include a stored gas canister that contains compressed gas (e.g., compressed air, nitrogen, argon, helium, etc.) at high pressure. The inflator 242 can include an initiator 246 (e.g., a pyrotechnic device such as a squib) operably positioned at one end and an outlet fitting 244 at the opposite end that connects the gas hose 124 to the inflator 242. In other embodiments, other suitable inflation devices well known in the art can be use without departing from the present disclosure. Such devices can include, for example, gas generator devices that generate high pressure gas through a rapid chemical reaction of an energetic propellant, hybrid inflators, etc. Accordingly, the present disclosure is not limited to any particular type of airbag inflation device and/or system.

The electronic assembly 252 can be electrically connected to the inflator initiator 246 via one or more electrical links 238 (e.g., one or more wires). As discussed above, in some embodiments the restraint system 110 can include a seatbelt switch (not shown) carried on a web connector 240 which is configured to change status (e.g., close a circuit or open a circuit) when the web connector 242 is suitably engaged with the buckle 116. The connector status as determined by the switch can be transmitted to the electronic assembly 252 via the electrical links 126a,b to ensure that the lap belt airbag 120 and/or the under-seat airbag 130 is only deployed when the two web portions 112a,b of the seatbelt web 118 are properly joined together, as this can prevent the under-seat airbag 130 from inadvertently inflating when the seatbelt 118 is not secured around the waist of a seat occupant.

In the illustrated embodiment, the electronic assembly 252 includes a processor 254 that receives electrical power from a power source 256 (e.g., one or more batteries, such as lithium batteries), a deployment circuit 262 that initiates the inflator 242, and at least one crash sensor 258 (e.g., an accelerometer) that detects rapid decelerations and/or other dynamic events greater than a preset or predetermined magnitude (e.g., a deceleration greater than 15 g's). The processor 254 can include, for example, suitable processing devices for executing non-transitory instructions stored on a computer-readable medium. The crash sensor 258 can, for example, include a spring-mass damper type sensor with an inertial switch calibrated for the vehicles operating environments that initiates airbag deployment upon a predetermined level of deceleration. In other embodiments, the crash sensor 258 can include other types of sensors known in the art and/or other additional features to facilitate airbag deployment. In further embodiments, some of the components of the electronic assembly 252 described above may be omitted and/or other components may be included. Although specific circuitry is described above, those or ordinary skill in the art will recognize that a microprocessor-based system could also be used where any logical decisions are configured in software.

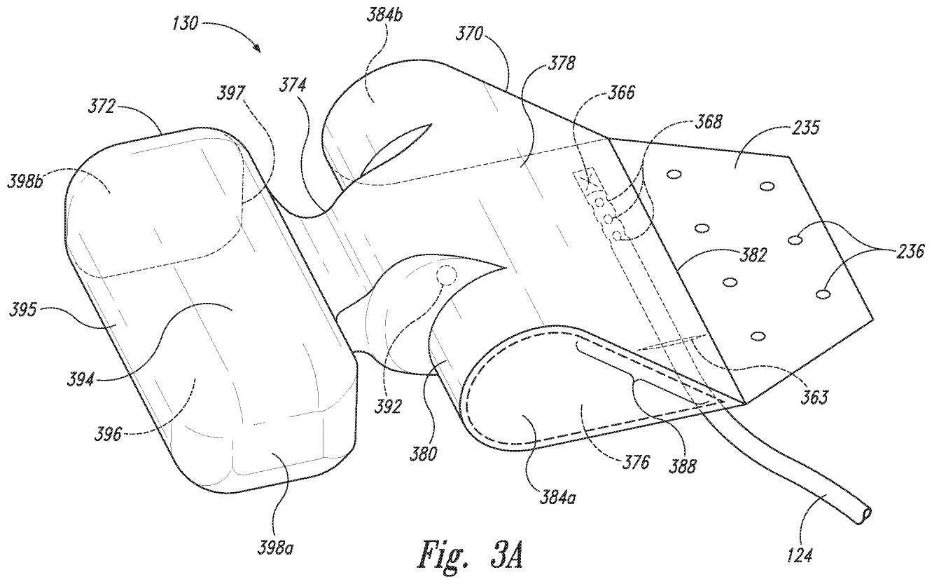

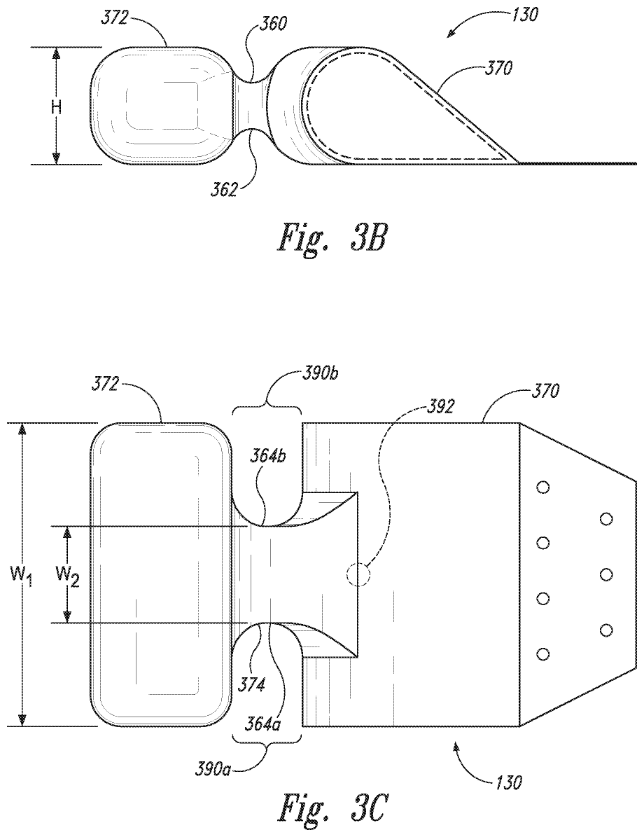

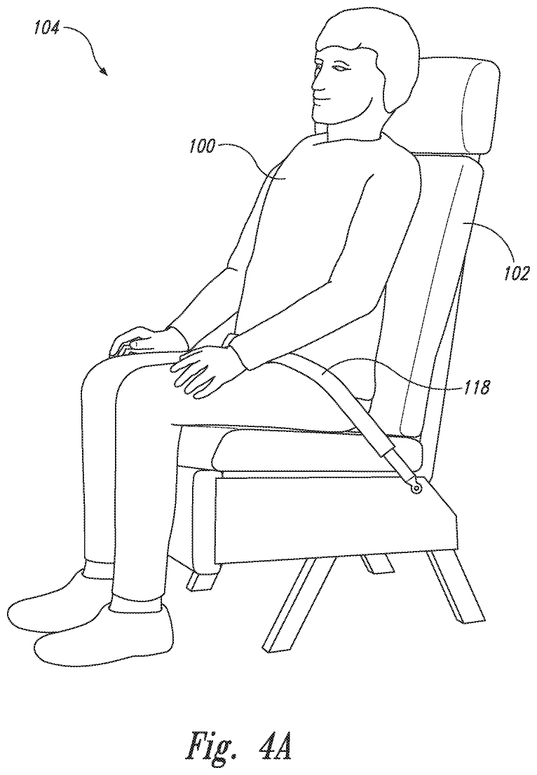

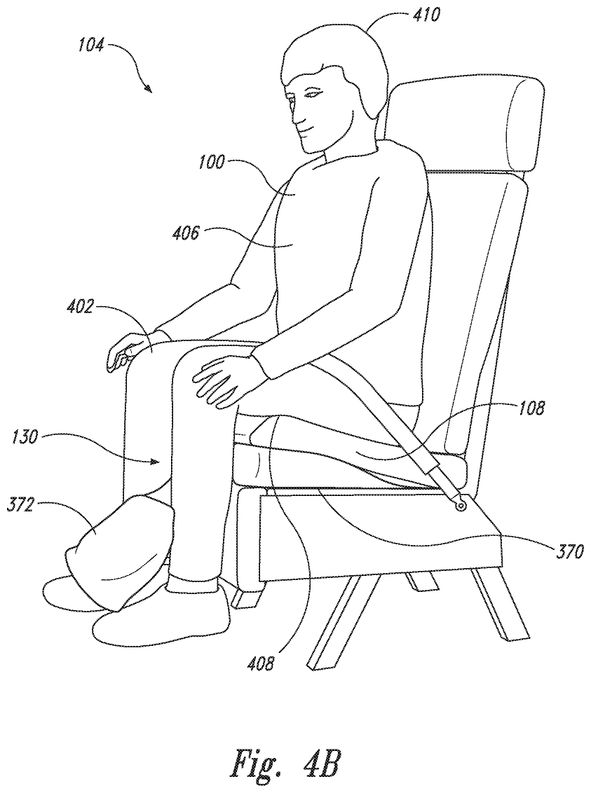

In a dynamic event above a predetermined threshold (e.g., a rapid deceleration equal to or greater than a predetermined magnitude resulting from the aircraft experiencing a collision or other significant dynamic event), the crash sensor 258 can detect the event and respond by sending a corresponding signal to the processor 254 that causes the processor 254 to send a corresponding signal to the deployment circuit 262. Upon receiving the signal and confirmation that the connector 240 is engaged with the buckle 116, the deployment circuit 262 applies a voltage to the inflator initiator 246 via the electrical link 238 sufficient to activate the initiator 246, which in turn opens or otherwise causes the inflator 242 to rapidly discharge its compressed gas into the under-seat air bag 130 via the gas hose 124. The rapid expansion of the compressed gas flowing into the under-seat airbag 130 causes the airbag 130 to rapidly expand and rupture or otherwise separate one or more of the tear seams 234a-c, causing the cover 134 to quickly move away from the airbag 130 so that the airbag 130 can rapidly inflate to full deployment in, for example, about 40 to 55 ms. Additional details regarding deployment of the under-seat airbag 130 are provided below with reference to FIGS. 3A-4C.

The airbag deployment systems described above and elsewhere herein are provided by way of examples of suitable such systems. It should be noted, however, that the various embodiments of the airbags described herein are not limited to use with the particular inflation and/or other systems described above and can also be used with other types of inflation systems without departing from the present disclosure.

FIG. 3A is a top isometric view of the under-seat airbag 130 configured in accordance with embodiments of the present technology, and FIGS. 3B and 3C are corresponding side and top views, respectively, of the under-seat airbag 130. Referring to FIGS. 3A-3C together, the under-seat airbag 130 includes a first airbag portion 370 (e.g., an under-seat portion) and a second airbag portion 372 (e.g., a leg restraint portion) which are connected to each other in fluid communication by a third airbag portion 374 (e.g., a connecting portion). In the illustrated embodiment, the first airbag portion 370 includes a bottom panel 376 and a top panel 378 that are joined together by a rear seam 382. In the illustrated embodiment, the top and bottom panels 378 and 376, respectively, can be generally flat and define an acute angle therebetween (e.g., an angle of from about 10 degrees to about 60 degrees, or from about 15 degrees to about 50 degrees, or about 45 degrees). A front panel 380 defines a cylindrical surface that transitions from the bottom panel 376 to the upper panel 378. A left side panel 384a and a right side panel 384b are joined to the bottom panel 376, the front panel 380, and the top panel 378 along corresponding seams in a known manner to generally form the enclosure of the first airbag portion 370. The foregoing configuration can give the first airbag portion 370 a generally tapered or triangular profile shape that, as described in greater detail below, can advantageously raise the forward edge portion of the seat cushion 108 more than the aft edge portion during inflation.

The third airbag portion 374 extends forwardly from the first airbag portion 370 and defines an open passage from the first airbag portion 370 to the second airbag portion 372. In the illustrated embodiment, the third airbag portion 374 includes a top panel 360, a bottom panel 362, and corresponding left and right side panels 364a and 364b, respectively, which are joined together by corresponding seams in a known manner to form generally concave panels around the third airbag portion 374.

In some embodiments, the second airbag portion 372 can have a generally rectangular shape with rounded corners. For example, the second airbag portion 372 can include a top panel 394, a bottom panel 396, and a front panel 395 and left and right side panels 398a and 398b, respectively, extending therebetween. Additionally, the second airbag portion 372 can include a rear panel 397 that is joined to the third airbag portion 374 to provide an open passage therebetween. In addition to the foregoing features, in some embodiments the under-seat airbag 130 can further include the attachment panel 235 that extends rearwardly from the seam 382 that joins the aft edge portion of the top panel 378 to the aft edge portion of the bottom panel 376. The attachment panel 235 can include a plurality of the openings 236 that, as described above with reference to FIG. 2, receive fasteners or other means for attaching the under-seat airbag 130 and its cover 134 to the seat pan 132 as described above with reference to FIG. 1.

As shown in FIG. 3C, in the illustrated embodiment the second airbag portion 372 has a first width W₁ and the third airbag portion 374 has a second width W₂ that is less than the first width W₁. The difference in these widths creates a first gap 390a between the first airbag portion 370 and the second airbag portion 372 on a first side of the third airbag portion 374, and a corresponding second gap 390b on the opposite side of the third airbag portion 374. As described in greater detail below, the gaps 390a,b are shaped and sized to receive the lower leg portions of the seat occupant upon inflation of the under-seat airbag 130. When the lower portions of the occupant's legs are positioned in the gaps 390a,b, the second airbag portion 372 acts as a restraint that limits or reduces the forward extension/motion of the occupant's legs during a rapid deceleration or other dynamic event that would otherwise cause the occupant's legs to move rapidly forward.

In addition to the widths W₁ and W₂, the second airbag potion 372 can also have a height H. By way of example only, in some embodiments the first width W₁ can be from about one foot to about three feet, or about two feet; the second width W₂ can be from about two inches to about one foot, or about six inches; and the height H can be from about four inches to about one foot, or about eight inches. In other embodiments, the first airbag portion 370, the second airbag portion 372, and/or the third airbag portion 374 can have other shapes and sizes without departing from the present disclosure.

As show in FIG. 3A, the gas hose 124 can extend into the interior of the first airbag portion 370 via an opening 363 (e.g., a slit) in the bottom panel 376. A distal end portion of the gas hose 124 is securely attached to the bottom panel 376 by stitching 366 or by other suitable attachments means. The distal end portion of the gas hose 124 also includes a plurality of openings 368 configured to permit high pressure gas from the inflator 242 (FIG. 2) to flow rapidly into the under-seat airbag 130 via the gas hose 124.

In some embodiments, the under-seat airbag 130 can include one or more tear seams 388 that prevent the airbag from fully inflating if the seat occupant is in a “brace” position. More specifically, the tear seam 388 can be a pressure sensitive seam having stitching that ruptures if the internal pressure within the airbag 130 prematurely exceeds a preset maximum as a result of the occupant's upper torso being positioned on or just above the occupant's thighs, as would be the case if the occupant was in the brace position. Preventing the under-seat airbag 130 from fully inflating when the occupant is in the brace position reduces the ability of the airbag 130 to push the occupant upwardly and out of the brace position (which is a relatively safe position in a crash event). In some embodiments, the tear seam 388 can also rupture once the under-seat airbag 130 fully inflates so that the airbag 130 quickly deflates and does not impede occupant egress away from the seating area. Additionally, in some embodiments the airbag 130 can also include one or more vents, such as one or more vent holes 392 formed in the bottom panel 376 of the first airbag portion 370. The vent hole 392 can be appropriately shaped and sized to cause the under-seat airbag 130 to rapidly deflate after full inflation to not impede occupant egress away from the seat 102 (FIG. 1).

The under-seat airbag 130 can be manufactured using various types of suitable airbag materials and construction techniques known to those of ordinary skill in the art. For example, in some embodiments the under-seat airbag 130 can be constructed by sewing together a plurality of panels or sheets of suitable material, such as silicon coated nylon fabric (e.g., 315 denier silicon coated woven nylon fabric), that are cut or otherwise formed to shape in the flat pattern. The panels can be sewn together with a suitable thread using known techniques. The attachment panel 235 can be composed of one or more layers of airbag material that are not inflated during airbag deployment. In other embodiments, airbags configured in accordance with the present disclosure can be constructed using other suitable materials in construction techniques known in the art.

FIGS. 4A-4C are a series of side isometric views illustrating various stages of operation of the under-seat airbag 130 in accordance with embodiments of the present technology. Referring first to FIG. 4A, this figure illustrates the seating area 104 in a pre-airbag deployment stage with the occupant 100 seated in the seat 102 and the lap seat belt 118 properly secured around the occupant's waist. In FIG. 4A, the seat 102 is a forward-facing seat in the seating area 104 as described above with reference to FIG. 1. Although not shown in FIG. 4A, the seat 102 can be positioned behind a strike hazard, such as, for example, the seat back of the seat positioned directly in front of the seat 102, a monument, a closet or galley wall, a partition, etc. In other embodiments, the seat 102 can be other types of seats in other positions and orientations, such as an oblique seat.

FIG. 4B illustrates the seating area 104 at the initial stage of the crash or other rapid deceleration event above a preset magnitude. The rapid deceleration event causes the occupant's torso 406 to begin rotating forward about the lap belt 118. The event also causes the airbag deployment system 200 (FIG. 2) to initiate rapid inflation of the under-seat airbag 130. As the under-seat airbag 130 inflates, the first airbag portion 370 pushes at least a forward portion of the seat cushion 108 upwardly and against the occupant's thighs 408 just behind the occupant's knees 402. This drives the occupant's legs 404 upwardly toward the occupant's torso 406. At the same time, the second and third airbag portions 372 and 374, respectively, unfurl outwardly between the occupant's legs 404 from underneath the seat cushion 108 and begin to inflate.

FIG. 4C illustrates the under-seat airbag 130 when it or near full inflation. As the first airbag portion 370 inflates and drives the occupant's legs 404 upwardly, the upward and/or rearward momentum of the legs 404 counteracts the forward rotation of the occupant's torso 406 (and/or is reacted by the occupant's torso 406), thereby reducing forward rotation of the occupant's torso 406 about the lap seat belt 118. This reduces the forward excursion of the occupant's head 410 toward the forward strike hazard. Additionally, lifting the occupant's legs 404 in this manner reduces the tendency of the occupant 100 to translate forward on the seat pan 132, which can further reduce forward head excursion. It is believed that reduction of forward head excursion in the foregoing manner can also reduce lumbar loads and potential related injuries to the occupant 100.

As shown in FIG. 4C, the second airbag portion 372 inflates directly in front (i.e., in direction F as shown in FIG. 1) of the lower portions of the occupant's legs 404. That is, when the second airbag portion 372 is fully inflated the lower portion of the occupant's left leg is positioned in the first gap 390a between the first airbag portion 370 and the second airbag portion 372, and the lower portion of the occupant's right leg is positioned in the second gap 390b between the first airbag portion 370 and the second airbag portion 372. In this configuration, the second airbag portion 372 is positioned between the occupant's legs 404 and a forward strike hazard and prevents or at least restricts forward extension and/or other movement of the legs 404 toward the strike hazard. As a result, the second airbag portion 372 can reduce the potential for occupant injuries resulting from leg flail.

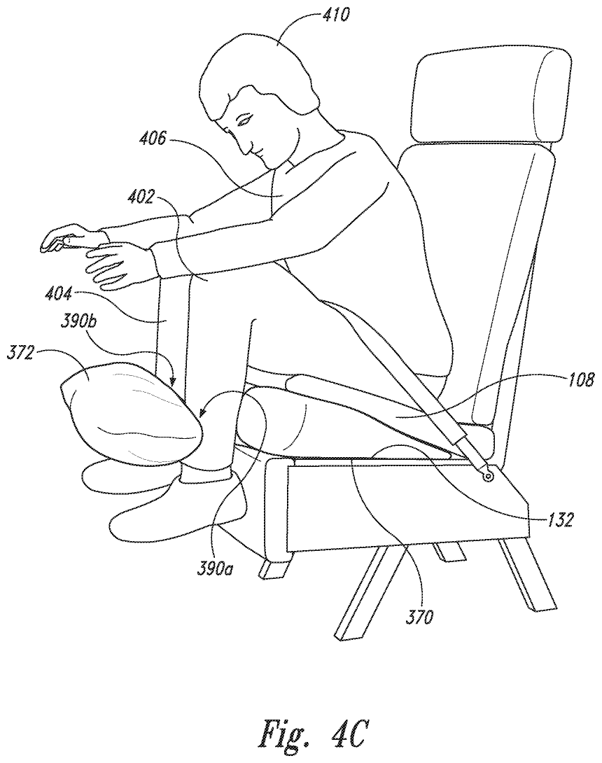

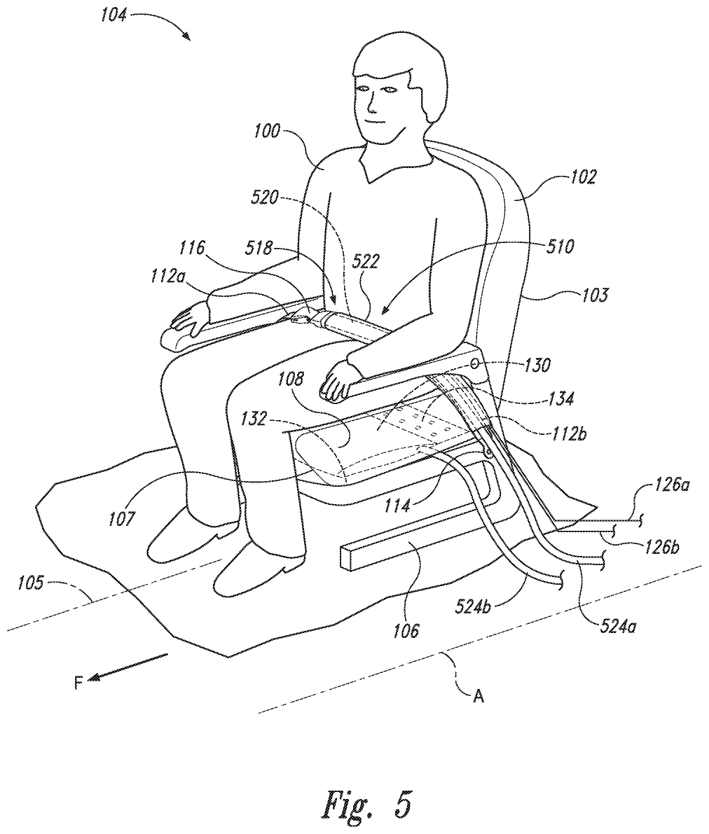

FIG. 5 is a front isometric view of the seat occupant 100 secured in the seat 102 by a restraint system 510 configured in accordance with another embodiment of the present technology. In the illustrated embodiment, the seat 102 is positioned in the aircraft seating area 104 as described above with reference to FIG. 1. Accordingly, the description of the seating area 104, the seat 102, and/or other aspects of the seating arrangement described above with reference to FIG. 1 can also apply to FIG. 5.

In the illustrated embodiment, the restraint system 510 includes a lap belt airbag 520 in addition to the under-seat airbag 130. The lap belt airbag 520 is carried on a lap seatbelt 518 that is at least generally similar in structure and function to the lap seatbelt 118 described above with reference to FIG. 1. For example, the lap seatbelt 518 includes a first web portion 112a and a second web portion 112b. In this embodiment, however, the lap belt airbag 520 is operably attached to the second web portion 112b of the seatbelt 518. During assembly, the airbag 520 is folded and stowed under a flexible cover 522 which encloses the airbag 520 and can wrap around at least a portion of the second web portion 112b. A first gas conduit or hose 524a extends from the airbag 520 and is operably coupled in fluid communication to an airbag inflator (not shown in FIG. 5). Additionally, in some embodiments a first electrical link, e.g., a first wire 126a, and a second wire 126b can be routed under the cover 522 to a seatbelt switch (not shown) that completes a circuit or is otherwise operable to indicate when the connector tongue on the second web portion 112b is properly coupled to the buckle 116, which can be a precondition for deployment of the lap belt airbag 520 and the under-seat airbag 130. As described in greater detail below, upon inflation of the lap belt airbag 520 in response to, for example, a rapid deceleration of the aircraft or other accident scenario, the airbag 520 ruptures a pressure sensitive tear seam in the cover 522 that enables the cover 522 to fall away so that the airbag 520 can fully deploy.

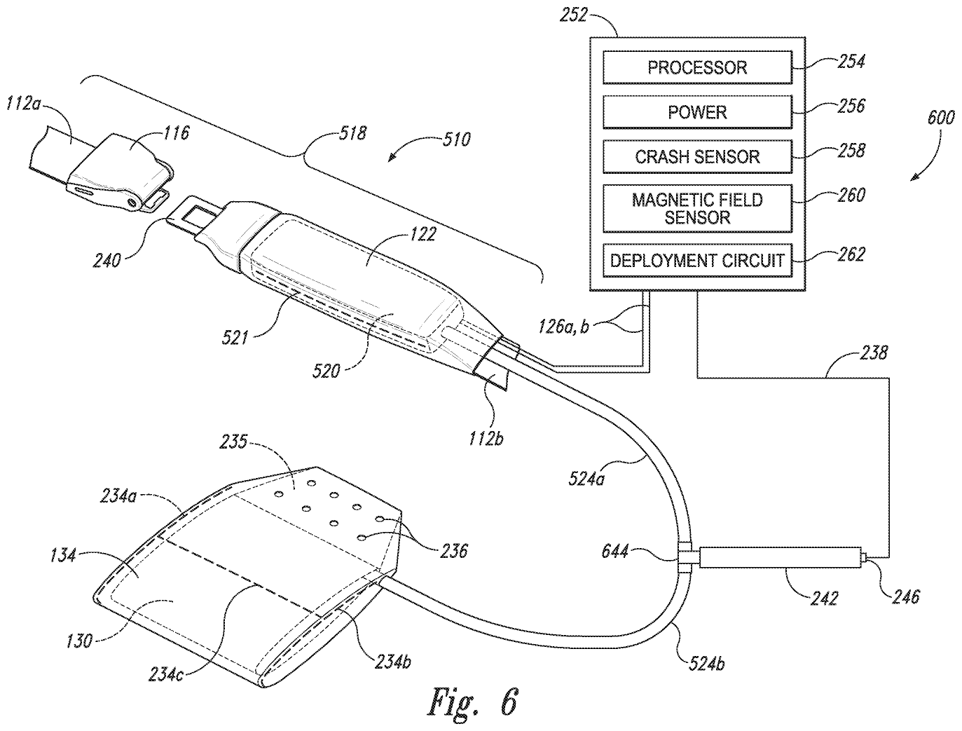

In the illustrated embodiment, a second gas hose 524b operably connects the under-seat airbag 130 in fluid communication with an inflator (not shown in FIG. 5). As described in greater detail below with reference to FIG. 6, the inflator can be a single inflator that provides high pressure gas to both the under-seat airbag 130 and the lap belt airbag 520, or a separate inflator that just provides high pressure gas to the under-seat airbag 130. Additionally, in some embodiments the under-seat air bag 130 can be inflated by a dedicated inflator that is positioned within the under-seat airbag 130.

FIG. 6 is a partially schematic isometric view of the restraint system 510 and an associated airbag deployment system 600 configured in accordance with embodiments of the present technology. In some embodiments, the airbag deployment system 600 can include an electronic assembly 252 and an inflator 242 as described above with reference to FIG. 2. The inflator 242 can include an initiator 246 operably positioned at one end and an outlet fitting 644 (e.g., a “T” fitting) at the opposite end that connects the first gas hose 524a and the second gas hose 524b to the inflator 242. In other embodiments, other suitable inflation devices well known in the art can be used without departing from the present disclosure. Such devices can include, for example, gas generator devices that generate high pressure gas through a rapid chemical reaction of an energetic propellant, hybrid inflators, etc. Additionally, in other embodiments the airbag deployment system 600 can include two inflators: one for inflating the lap belt airbag 520 and the other for inflating the under-seat airbag 130. In further embodiments, the under-seat airbag 130 can include a dedicated inflator positioned within the airbag 130. Accordingly, the present disclosure is not limited to any particular type of airbag inflation device and/or system.

The electronic assembly 252 can be electrically connected to the inflator initiator 246 via one or more electrical links 238 (e.g., one or more wires). As discussed above, in some embodiments the restraint system 510 can include a seatbelt switch (not shown) carried on a web connector 240 which is configured to change status (e.g., close a circuit or open a circuit) when the web connector 242 is suitably engaged with the buckle 116. The connector status as determined by the switch can be transmitted to the electronic assembly 252 via the electrical links 126a,b to ensure that the lap belt airbag 520 and the under-seat airbag 130 are only deployed when the two web portions 112a,b of the seatbelt web 518 are properly joined together, as this can prevent the lap belt airbag 520 and the under-seat airbag 130 from inadvertently inflating when the seatbelt 518 is not secured around the waist of a seat occupant.

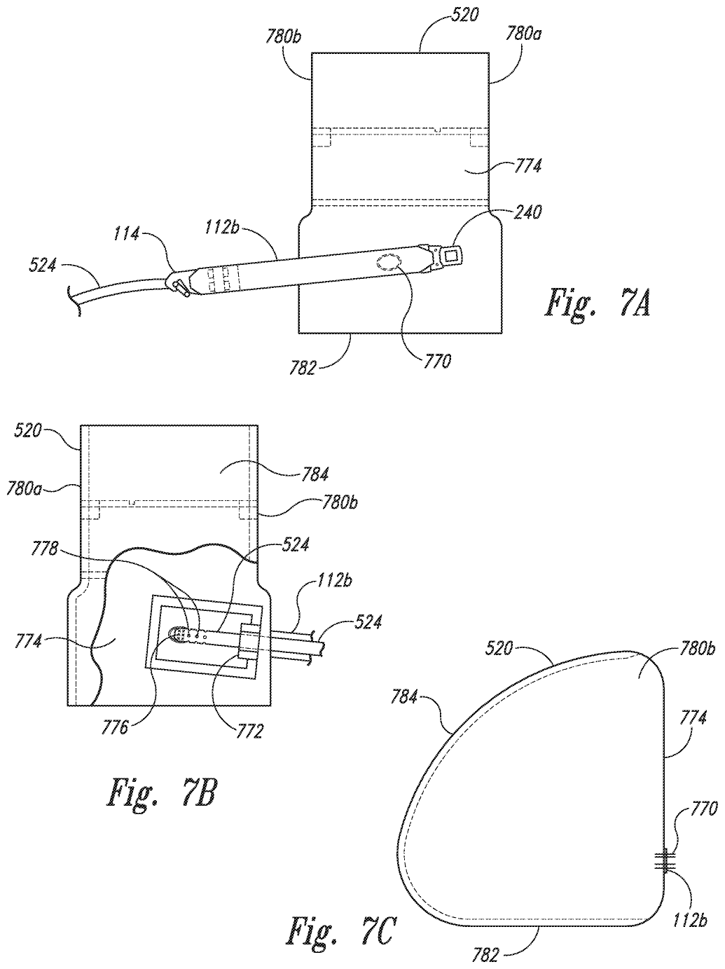

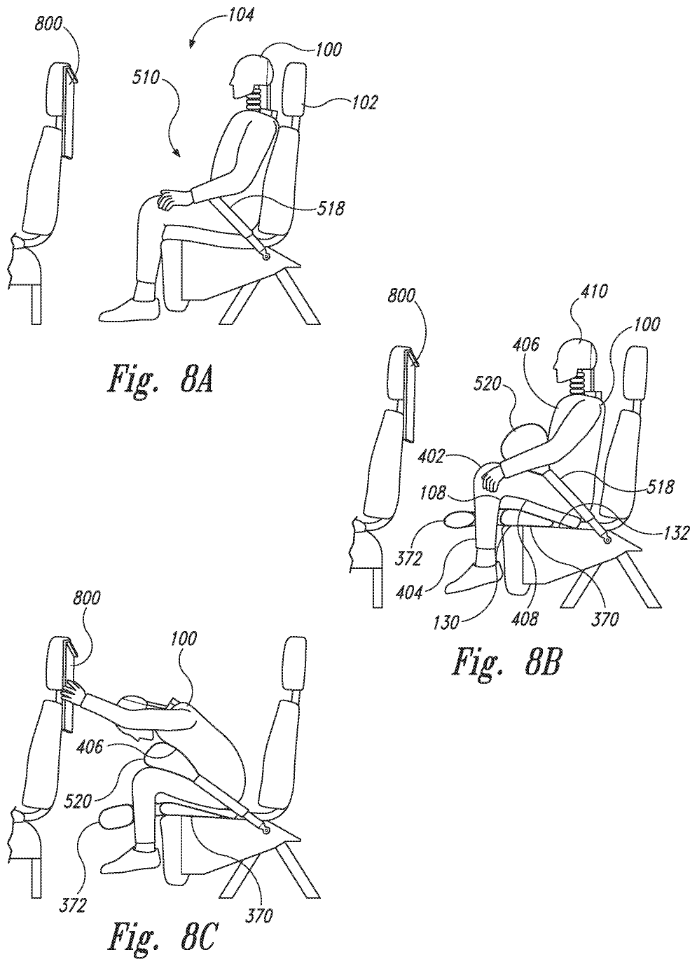

In a dynamic event above a predetermined threshold (e.g., a rapid deceleration equal to or greater than a predetermined magnitude resulting from the aircraft experiencing a collision or other significant dynamic event), the crash sensor 258 can detect the event and respond by sending a corresponding signal to the processor 254 that causes the processor 254 to send a corresponding signal to the deployment circuit 262. Upon receiving the signal and confirmation that the connector 240 is engaged with the buckle 116, the deployment circuit 262 applies a voltage to the inflator initiator 246 via the electrical link 238 sufficient to activate the initiator 246, which in turn opens or otherwise causes the inflator 242 to rapidly discharge its compressed gas into the lap belt airbag 520 and the under-seat air bag 130 via the first gas hose 524a and the second gas hose 524b, respectively. The rapid expansion of the compressed gas flowing into the lap belt airbag 520 causes the airbag 520 to rapidly inflate and rupture or otherwise separate a tear seam 521 on the airbag cover 522. This moves the cover 522 away from the lap belt airbag 520 so that the air bag 520 can quickly inflate and deploy (e.g., in about 40 to 55 milliseconds (ms)). Similarly, rapid expansion of the compressed gas flowing into the under-seat airbag 130 causes the airbag 130 to rapidly expand and rupture or otherwise separate the tear seams 234a-c on the cover 134, enabling the airbag 130 to rapidly inflate to full deployment in, for example, about 40 to 55 ms. Accordingly, in some embodiments the lap belt airbag 520 and the under-seat airbag 130 can be configured to inflate and deploy simultaneously, or at least approximately simultaneously, in about 55 ms or less. Additional details regarding deployment of the lap belt airbag 520 and the under-seat airbag 130 are provided below with reference to FIGS. 7A-8C.

The airbag deployment systems described above and elsewhere herein are provided by way of examples of suitable such systems. It should be noted, however, that the various embodiments of the airbags described herein are not limited to use with the particular inflation and/or other systems described above and can also be used with other types of inflation systems without departing from the present disclosure.

FIG. 7A is a rear view, FIG. 7B is a partially cut-away front view, and FIG. 7C is a side view of the lap belt airbag 520 configured in accordance with embodiments of the present technology. Referring to FIGS. 7A-7C together, the lap belt airbag 520 is illustrated in a fully inflated and deployed configuration, and includes a rear portion or panel 774, a bottom panel 782, a front panel 784 and first and second side panels 780a and 780b, respectively. As will be appreciated by those of ordinary skill in the art, although the foregoing portions of the lap belt airbag 520 have been described herein as “panels” for ease of reference, two or more of these panels can be formed from the same piece of material that is cut to shape in the flat pattern and folded about appropriate fold lines and/or joined together by one or more seems in a conventional manner.

As shown in FIG. 7A, the second web portion 112b of the seatbelt 518 (FIG. 5) can be sewn or otherwise attached to the rear panel 774 of the airbag 520 via stitching 770 and/or other suitable fastening means proximate to the web connector tongue 240. As shown in FIG. 7B, the rear panel 774 includes an opening 772 (e.g., a slit) through which the first gas hose 524a extends into the interior of the lap belt airbag 520. A distal end portion of the first gas hose 524a is attached to the rear panel 774 by stitching 776 and/or other suitable fastening means known in the art. Additionally, the first gas hose 524a includes a plurality of openings 778 proximate the distal end portion that enable the high-pressure gas from the inflator 242 (FIG. 5) to rapidly flow into the lap belt airbag 520 for inflation thereof.

In some embodiments, the lap belt airbag 520 can have a generally triangular or “wedge” profile shape when the lap belt 520 is fully inflated as shown in FIG. 7C. More specifically, in some embodiments the rear panel 774 can extend generally perpendicular to the bottom panel 782, and the front panel 784 can have a generally convex and curved shape that extends at an angle to connect the bottom panel 782 to the rear panel 774. Additionally, in some embodiments, the lap belt airbag 520 can be configured so that the rear panel 774 does not extend past the chest of the seat occupant 100 (FIG. 5) when fully inflated. In these embodiments, for example, the airbag 520 would not be positioned in front of the occupant's head when fully inflated. In other embodiments, the lap belt airbag can have other shapes and sizes.

Although not shown, in some embodiments the lap belt airbag 520 can include one or more vents (e.g., passive vents or active vents) that enable the airbag 520 to rapidly deflate after deployment. For example, in some embodiments the airbag 520 can include an opening, e.g., a hole, a tear seam that ruptures when the airbag fully inflates and reaches a sufficient internal pressure, and/or another form of “passive” vent. In other embodiments, the lap belt airbag 520 (and/or the under-seat airbag 130) can include an active vent as described in one or more of the patents or patent applications incorporated herein by reference. In yet other embodiments, airbag vents can be omitted.

The lap belt airbag 520 can be manufactured using various types of suitable airbag materials and construction techniques known to those of ordinary skill in the art. For example, in some embodiments the lap belt airbag 520 can be constructed by sewing together a plurality of panels or sheets of suitable material, such as silicon coated nylon fabric (e.g., 315 denier silicon coated woven nylon fabric), that are cut or otherwise formed to shape in the flat pattern. The panels can be sewn together with a suitable thread using known techniques.

FIGS. 8A-8C are a series of side views illustrating various stages of deployment of the under-seat airbag 130 the lap belt airbag 520 and in accordance with embodiments with the present technology. Referring first to FIG. 8A, this Figure illustrates the airbags 130, 520 in a pre-deployment stage in which the occupant 100 is seated in the seat 102 with the lap seatbelt 518 properly secured around the occupant's waist. In FIG. 8A, the seat 102 is a forward-facing seat positioned behind a strike hazard 800. The strike hazard 800 can be virtually any type of structure typically found in front of a passenger seat or other seat (e.g., a pilot seat, flight attendant seat, etc.) on an aircraft, and can include, for example, the seatback of the seat positioned directly in front of the seat 802, a closet or galley wall or partition, a monument, etc. Although the seat 102 is illustrated as a forward-facing seat, in other embodiments the seat 102 can be other types of seats in other orientations, such as an oblique seat as described above.

FIG. 8B illustrates the seating area 104 at the initial stage of a crash or other rapid deceleration event above a preset magnitude. The rapid deceleration event causes the occupant's torso 406 to begin rotating forward about the lap belt 518. The event also causes the airbag deployment system 600 (FIG. 6) to initiate rapid inflation of the under-seat airbag 130 and the lap belt airbag 520. As the under-seat airbag 130 inflates, the first airbag portion 370 expands and pushes the seat cushion 108 upwardly against the occupant's thighs 408 just behind the occupant's knees 402. Additionally, the third airbag portion 374 (FIGS. 3A-3C) inflates forwardly from the first airbag portion 370 between the occupant's legs 404, and the second airbag portion 372 inflates from the third airbag portion 374 and extends laterally in front of the lower portions of the occupant's legs 404. The upward force from expansion of the first airbag portion 370 drives the occupant's legs 404 upwardly toward the occupant's torso 406, while inflation of the second airbag portion 372 in front of the occupant's legs 404 can restrain the occupant's legs 404 and prevent or at least reduce potentially harmful forward leg flail. At the same time, the lap belt airbag 520 inflates and expands between the occupant's torso 406 and the occupant's thighs 408 as the occupant's torso 406 rotates forwardly about the lap belt 518. As a result, the upward momentum of the legs 404 is reacted by the occupant's torso 406 through the lap belt airbag 520, thereby reducing the forward rotation of the torso 406 and the overall forward excursion of the occupant's head 410 toward the strike hazard 800. Additionally, lifting the occupant's legs 404 in this manner cam reduce the tendency of the occupant 100 to translate forward on the seat pan 132, which can further reduce forward head excursion.

FIG. 8C illustrates the occupant 100 at a state of maximum forward head excursion. As this view illustrates, the combination of the inflated under-seat airbag 130 and the inflated lap belt airbag 520 can substantially reduce forward head excursion and prevent the occupant's head 410 from impacting the strike hazard 800. It is also believed that reduction of forward head excursion in this manner can reduce lumbar loads and associated injuries to the occupant 100. Additionally, as noted above the second airbag portion 372 can concurrently reduce forward leg flail and the potential for associated injuries.

One advantage of reducing occupant head excursion and/or lower leg flail with the airbags 130 and/or 520 described above is that it can enable airlines to place seats closer to potential head strike hazards, while still maintaining enough distance to the head strike hazard to avoid potentially injurious contact by the occupant in the event of a crash or other rapid deceleration event. Another benefit of embodiments of the present technology is that by concealing the under-seat airbag 130 beneath the seat cushion 108 and/or integrating the airbag 130 into the seat cushion 108, the airbag does not affect the cosmetics of the seating area 104. Additionally, by positioning the under-seat airbag 130 beneath the cushion 108 or a potion thereof, it does not adversely affect the comfort of the seat 102 for the occupant 100.

Various airbag systems and associated components are described in U.S. Pat. Nos.: 5,984;350; 6,957,828; 6,439,600; 6,535,115; 6,217,066; 7,665,761; 7,980,590; 8,439,398; 8,556,293; 8,469,397; 8,403,361; 8,818,759; 8,523,220; 9,156,558; 9,176,202; 9,352,839; 9,944,245; 9,511,866; 9,925,950; in U.S. patent application Ser. Nos.: 13/170,079; 14/468,170; 14/808,983; and in U.S. Provisional Patent Application No.: 62/495,602, each of which is incorporated herein by reference in its entirety. Indeed, any patents, patent applications and other references identified herein are incorporated herein by reference in the entirety, except for any subject matter disclaimers or disavowals, and except to the extent that the incorporated material is inconsistent with the express disclosure herein, in which case the language in this disclosure controls. Aspects of the invention can be modified, if necessary, to employ the systems, functions, and concepts of the various references described above to provide yet further implementations of the invention.

References throughout the foregoing description to features, advantages, or similar language do not imply that all of the features and advantages that may be realized with the present technology should be or are in any single embodiment of the invention. Rather, language referring to the features and advantages is understood to mean that a specific feature, advantage_{;} or characteristic described in connection with an embodiment is included in at least one embodiment of the present technology. Thus, discussion of the features and advantages, and similar language, throughout this specification may, but do not necessarily, refer to the same embodiment.

Furthermore, the described features, advantages, and characteristics of the present technology may be combined in any suitable manner in one or more embodiments. One skilled in the relevant art will recognize that the present technology can be practiced without one or more of the specific features or advantages of a particular embodiment. In other instances, additional features and advantages may be recognized in certain embodiments that may not be present in all embodiments of the present technology.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The teachings of the invention provided herein can be applied to other systems, not necessarily the system described above. The elements and acts of the various examples described above can be combined to provide further implementations of the invention. Some alternative implementations of the invention may include not only additional elements to those implementations noted above, but also may include fewer elements. Further any specific numbers noted herein are only examples: alternative implementations may employ differing values or ranges.

While the above description describes various embodiments of the invention and the best mode contemplated, regardless how detailed the above text, the invention can be practiced in many ways. Details of the system may vary considerably in its specific implementation, while still being encompassed by the present disclosure. As noted above, particular terminology used when describing certain features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed in the specification, unless the above Detailed Description section explicitly defines such terms. Accordingly, the actual scope of the invention encompasses not only the disclosed examples, but also all equivalent ways of practicing or implementing the invention under the claims.

From the foregoing, it will be appreciated that specific embodiments of the invention have been described herein for purposes of illustration, but that various modifications may be made without deviating from the spirit and scope of the various embodiments of the invention. Further, while various advantages associated with certain embodiments of the invention have been described above in the context of those embodiments, other embodiments may also exhibit such advantages, and not all embodiments need necessarily exhibit such advantages to fall within the scope of the invention. Accordingly, the invention is not limited, except as by the appended claims.

Although certain aspects of the invention are presented below in certain claim forms, the applicant contemplates the various aspects of the invention in any number of claim forms. Accordingly, the applicant reserves the right to pursue additional claims after filing this application to pursue such additional claim forms, in either this application or in a continuing application.

The following disclosure describes various embodiments of airbags and the associated systems for use with seats in aircraft. As described in greater detail below, and some embodiments

I/We claim:

1. An under-seat airbag comprising:
a first airbag portion configured to be positioned proximate to a seat pan and inflate upwardly therefrom beneath a seat occupant; and
a second airbag portion in fluid communication with the first airbag portion, wherein the second portion is configured to inflate outwardly from the first airbag portion and at least partially extend in front of the seat occupant's legs.

2. The under-seat airbag of claim 1 wherein the second airbag portion is configured to inflate outwardly from the first airbag portion and extend laterally in front of the seat occupant's legs.

3. The under-seat airbag of claim 1 wherein the second airbag portion is configured to inflate outwardly from the first airbag portion such that the seat occupant's lower legs are positioned between the first airbag portion and the second airbag potion.

4. The under-seat airbag of claim 1 wherein the second airbag portion is configured to inflate outwardly between the legs of the occupant.

5. The under-seat airbag of claim 1 wherein the first airbag portion is configured to inflate and raise the thighs of the occupant away from the seat pan, and wherein the second airbag portion is configured to inflate and hinder outward movement of the lower legs of the occupant away from the seat pan.

6. The under-seat airbag of claim 1, further comprising a third airbag portion in fluid communication with the first airbag portion, wherein, when inflated:
the third airbag portion extends forward from the first airbag portion between the first airbag portion and the second airbag portion, and
the second airbag portion has a first width and the third airbag portion has a second width that is less than the first width.

7. The under-seat airbag of claim 6 wherein, when inflated, the under-seat airbag defines a first gap between the first airbag portion and the second airbag portion configured to receive the left leg of the seat occupant on one side of the third airbag portion, and a second gap between the first airbag portion and the second airbag portion configured to receive the right leg of the seat occupant on the other side of the third airbag portion.

8. The under-seat airbag of claim 1 wherein the first and second airbag portions are configured to be stowed in an uninflated state between the seat pan and a seat cushion supported by the seat pan.

9. The under-seat airbag of claim 1 wherein the seat pan is a seat pan of an aircraft seat, and wherein the under-seat airbag is configured to be used with the aircraft seat.

10. An airbag system configured to protect an occupant seated in a seat, the airbag comprising:
an airbag including
a first portion attached to the seat; and
a second portion configured to inflate in front of the seat occupant's legs.

11. The airbag system of claim 10 wherein the seat includes a seat cushion, and wherein first portion is a first airbag portion configured to inflate upwardly against at least a portion of the seat cushion.

12. The airbag system of claim 10, further comprising an aircraft seat, wherein the first portion of the airbag is configured to be attached to the aircraft seat.

13. A restraint system for use with a seat in an aircraft, the restraint system comprising:
a web configured to be fastened around an occupant seated in the seat;
a first airbag attached to the web and configured to deploy therefrom; and
a second airbag including
a first airbag portion configured to be positioned proximate a base portion of the seat and inflate upwardly therefrom beneath the occupant; and
a second airbag portion in fluid communication with the first airbag portion and configured to inflate outwardly therefrom, wherein at least a portion of the second airbag portion is configured to inflate in front of the occupant's legs.

14. The restraint system of claim 13 wherein the web is a lap web configured to be fastened around the occupant's waist.

15. The restraint system of claim 13 wherein:
the web is a lap web configured to be fastened around the occupant's waist;
the first airbag is configured to deploy outwardly from the web between the occupant's torso and the occupant's thighs; and
the first airbag portion of the second airbag is configured to deploy upwardly beneath the occupant's thighs to raise the occupant's knees toward the first airbag.

16. The restraint system of claim 13, further comprising at least one inflator in fluid communication with the first and second airbags, wherein the at least one inflator is configured to rapidly inflate the first and second airbags in response to a dynamic event above a preset magnitude.

17. A method for reducing forward leg excursion of an occupant seated in an aircraft seat during a rapid deceleration event, the method comprising:
positioning an airbag proximate a base portion of the seat, the airbag having a first airbag portion and a second airbag portion; and
in response to detecting the rapid deceleration event, inflating the first airbag portion upwardly beneath the occupant's thighs, and inflating the second airbag portion in front of the occupant's lower legs.

18. The method of claim 17 wherein inflating the second airbag portion includes laterally extending the second airbag portion across front sides of lower portions of the occupant's legs.

19. The method of claim 17 wherein inflating the second airbag portion includes forming a first gap between the first airbag portion and the second airbag portion to one side of the airbag, and forming a second gap between the first airbag portion and the second airbag portion to the other side of the airbag, wherein the first gap is configured to at least partially receive a lower portion of the occupant's left leg, and wherein the second gap is configured to at least partially receive a lower portion of the occupant's right leg.

20. The method of claim 17 wherein inflating the first airbag portion raises the occupant's legs toward the occupant's torso.
